(19) United States
(12) Patent Application Publication
(10) Pub. No.: US 2024/0249114 A1
(43) Pub. Date: Jul. 25, 2024

(54) SEARCH SPACE LIMITATION APPARATUS, SEARCH SPACE LIMITATION METHOD, AND COMPUTER-READABLE RECORDING MEDIUM

(71) Applicant: NEC Corporation, Tokyo (JP)

(72) Inventor: Yuki Kobayashi, Tokyo (JP)

(73) Assignee: NEC Corporation, Tokyo (JP)

(21) Appl. No.: 18/413,223

(22) Filed: Jan. 16, 2024

(30) Foreign Application Priority Data
Jan. 25, 2023 (JP) 2023-009380

(51) Int. Cl. G06N 3/045

(52) U.S. Cl. CPC G06N 3/045

(57) ABSTRACT

A search space limitation apparatus including: an acquisition unit that acquires first neural network information, first search space information, and allowable distance information; a generation unit that generates neural network architecture information relating to the architecture of the first neural network, based on the first neural network information; a determination unit that determines a second search space which is a range, in the first search space, for searching for the architecture of the second neural network, based on the neural network architecture information, the first search space information and the allowable distance information; and an output control unit that outputs second search space information relating to the second search space to an output device.

### CROSS-REFERENCE TO RELATED APPLICATION

This application is based upon and claims the benefit of priority from Japanese patent applications No. 2023-009380, filed on Jan. 25, 2023, the disclosure of which is incorporated herein in its entirety by reference.

### BACKGROUND OF THE INVENTION

### 1. Field of the Invention

The present disclosure relates to a search space limitation apparatus, a search space limitation method, and a computer-readable recording medium.

### 2. Background Art

Neural architecture searches that search for architectures of neural networks capable of high-speed execution while maintaining high recognition accuracy have conventionally been performed by the intuition and experience of skilled AI (Artificial Intelligence) researchers and AI engineers.

In recent years, several techniques for automatically performing neural architecture searches (NAS) have been proposed. However, not only is the search space for neural network architectures huge but time-consuming “training” needs to be repeatedly performed during searches in order to evaluate the accuracy of the neural network architectures, requiring enormous computing resources and increasing the length of the search period. For example, one iteration of training could take anywhere from several hours to several days, and the training has to be repeatedly performed dozens of times during a search.

As a related technology, Non-Patent Document 1 (Barret Zoph and Quoc V. Le: “Neural Architecture Search with Reinforcement Learning”, [online], [Submitted on 5 Nov. 2016 (v1), last revised 15 Feb. 2017 (this version, v2)], Internet <URL: https://arxiv.org/abs/1611.01578>) discloses a technology that uses reinforcement learning to obtain a neural network architecture having a higher recognition accuracy than a human-designed neural network architecture. However, a problem lies in the enormous computational cost required to perform searches, such as the need to operate 800 GPUs (Graphics Processing Units) for extended periods.

As a related technology, Non-Patent Document 2 (Hanxiao Liu, et al.: “DARTS: Differentiable Architecture Search”, [online], [Submitted on 24 Jun. 2018 (v1), last revised 23 Apr. 2019 (this version, v2), Internet <https://arxiv.org/abs/1806.09055>) discloses a technology for performing searches that are not reliant on reinforcement learning, by making the search problem differentiable through continuous moderation. Non-Patent Document 3 (Xiao fan Zhang, et al.: “SkyNet: a Hardware-Efficient Method for Object Detection and Tracking on Embedded Systems”, [online], [Submitted on 20 Sep. 2019 (v1), last revised 29 Feb. 2020 (this version, v2), Internet <https://arxiv.org/abs/1909.09709>) discloses a technology for deriving a high-speed neural network architecture that is highly accurate, by combining components of efficient neural network architectures in a bottom-up manner. Non-Patent Document 4 (Golnaz Ghaisi, et al.: “NAS-FPN: Learning Scalable Feature Pyramid Architecture for Object Detection”, [online], [Submitted on 16 Apr. 2019], Internet <https://arxiv.org/pdf/1904.07392v1.pdf>) discloses a technology for optimizing the architecture of FPNs (Feature Pyramid Networks), particularly the connection architecture between different resolution data.

As a related technology, Patent Document 1 (Japanese Patent Laid-Open Publication No. 2019-175513) discloses a technology that uses one neural network to generate another neural network having a different network architecture. If the evaluation result of the other neural network that is generated exceeds the evaluation result of the one neural network, the other neural network is updated as a Pareto optimal solution. Searches for a network architecture suited to the environment can thereby be performed more efficiently.

As a related technology, Patent Document 2 (Japanese Patent No. 7111671) discloses the following technology. An architecture search unit that searches for a first learned model architecture in which search space information that meets the target constraints of target hardware is selected for each of a plurality of convolutional processing blocks included in the base model architecture of a neural network model. A neural network model suitable for the target hardware is thereby designed.

However, conventional techniques involve randomly searching a huge search space, and thus neural network architectures obtained as a result of searches often include irregular architectures or architectures whose purpose is difficult to comprehend, unlike human-designed neural network architectures. Thus, users of neural architecture search technologies are hesitant to utilize such technologies, with this being a factor hindering the dissemination of neural architecture search technologies.

The human-designed neural network architectures shown in the neural network architectures (M2Det) described in Non-Patent Document 5 (Kaiming He, et al.: “Deep Residual Learning for Image Recognition”, [online], [Submitted on 10 Dec. 2015], Neural network architecture (ResNet) on Internet <https://arxiv.org/pdf/1512.03385.pdf>) and Non-patent Document 6 (Qijie Zhao, et al.: “M2Det: A Single-Shot Object Detector Based on Multi-Level Feature Pyramid Network”, pp. 9259-9266, Vol. 33 No. 01: AAAI-19 [online], 2019 Jul. 17, Internet <https://doi.org/10.1609/aaai.v33101.33019259>), for example, are constituted by regularly repeating a certain regular substructure. However, the neural network architecture described in Non-Patent Document 2 (DARTS) and Non-Patent Document 4 have connections between irregular substructures or substructures whose purpose is difficult to comprehend.

### SUMMARY OF INVENTION

An example aspect of the disclosure is to reduce the possibility that a neural network generated by a neural architecture search will include an irregular architecture or an architecture whose purpose is difficult to comprehend.

In order to achieve the example object described above, a search space limitation apparatus according to an example aspect includes:
an acquisition unit that acquires first neural network information relating to a first neural network, first search space information relating to a first search space which is a range for searching for an architecture of a second neural network based on the first neural network, and allowable distance information relating to an allowable distance indicating a degree of change in an architecture allowed from an architecture of the first neural network in the first search space;
a generation unit that generates neural network architecture information relating to the architecture of the first neural network, based on the first neural network information;
a determination unit that determines a second search space which is a range, in the first search space, for searching for the architecture of the second neural network, based on the neural network architecture information, the first search space information and the allowable distance information; and
an output control unit that outputs second search space information relating to the second search space to an output device.

Also, in order to achieve the example object described above, a search space limitation method according to an example aspect for a computer to carry out:
acquiring first neural network information relating to a first neural network, first search space information relating to a first search space which is a range for searching for an architecture of a second neural network based on the first neural network, and allowable distance information relating to an allowable distance indicating a degree of change in an architecture allowed from an architecture of the first neural network in the first search space;
generating neural network architecture information relating to the architecture of the first neural network, based on the first neural network information;
determining a second search space which is a range, in the first search space, for searching for the architecture of the second neural network, based on the neural network architecture information, the first search space information and the allowable distance information; and
outputting second search space information relating to the second search space to an output device.

Furthermore, in order to achieve the example object described above, a computer-readable recording medium according to an example aspect includes a program recorded on the computer-readable recording medium, the program including instructions that cause the computer to carry out:
acquiring first neural network information relating to a first neural network, first search space information relating to a first search space which is a range for searching for an architecture of a second neural network based on the first neural network, and allowable distance information relating to an allowable distance indicating a degree of change in an architecture allowed from an architecture of the first neural network in the first search space;
generating neural network architecture information relating to the architecture of the first neural network, based on the first neural network information;
determining a second search space which is a range, in the first search space, for searching for the architecture of the second neural network, based on the neural network architecture information, the first search space information and the allowable distance information; and
outputting second search space information relating to the second search space to an output device.

According to the disclosure as described above, the possibility that a neural network generated by a neural architecture search will include an irregular architecture or an architecture whose purpose is difficult to comprehend can be reduced.

### BRIEF DESCRIPTION OF THE DRAWINGS

FIG. 1 is a diagram for describing an example of the search space limitation apparatus in the example embodiment.

FIG. 2 is a block diagram for describing an example of the overall configuration of the search space limitation apparatus in the example embodiment.

FIG. 3 is a diagram illustrating an example of a neural network model that is represented by neural network model information in the example embodiment.

FIG. 4 is a diagram illustrating an example of neural network architecture information in the example embodiment.

FIG. 5 is a diagram illustrating an example of input search space information in the example embodiment.

FIG. 6 is a diagram illustrating an example of limited search space information that is generated by the search space determination unit in the example embodiment.

FIG. 7 is a flowchart illustrating an example of the operations of the search space limitation apparatus in the example embodiment.

FIG. 8 is a diagram for describing an example of a computer that realizes the search space limitation apparatus in the example embodiments.

### EXAMPLE EMBODIMENTS

Hereinafter, an example embodiment will be described with reference to the drawings. Note that, in the drawings, elements having the same functions or corresponding functions are denoted by the same reference numerals, and repetitive description thereof may be omitted.

### Example Embodiment

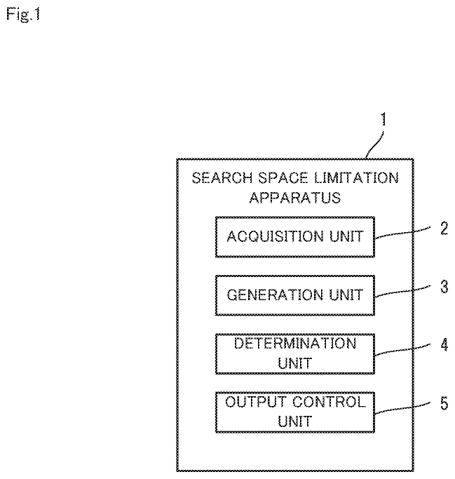

The configuration of a search space limitation apparatus in the example embodiment will be described using FIG. 1. FIG. 1 is a diagram for describing an example of the search space limitation apparatus in the example embodiment.

### [Apparatus Configuration]

A search space limitation apparatus 1 shown in FIG. 1 is a device that limits the search space in a search for a neural network architecture. A search space limitation apparatus 11 described later is given as an example of the search space limitation apparatus 1. Also, as shown in FIG. 1, the search space limitation apparatus 1 includes an acquisition unit 2, a generation unit 3, a determination unit 4 and an output control unit 5.

The acquisition unit 2 acquires first neural network information, first search space information and allowable distance information. The first neural network information is information relating to a first neural network. The first search space information is information relating to a first search space, which is a range for searching for an architecture of a second neural network based on the first neural network. The allowable distance information is information relating to an allowable distance indicating the degree of change in the architecture that is allowed from the architecture of the first neural network in the first search space. An acquisition unit 13 described later is given as an example of the acquisition unit 2. Neural network model information 22 described later is given as an example of the first neural network information. Input search space information 23 described later is given as an example of the first search space information. Allowable distance information 24 described later is given as an example of the allowable distance information.

The generation unit 3 generates neural network architecture information relating to the architecture of the first neural network, based on the first neural network information. A structural analysis unit 14 described later is given as an example of the generation unit 3. Neural network architecture information 25 described later is given as an example of the neural network architecture information.

The determination unit 4 determines a second search space, which is a range, in the first search space, for searching for an architecture of the second neural network, based on the neural network architecture information, the first search space information and the allowable distance information. A search space determination unit 15 described later is given as an example of the determination unit 4. A search space indicated by limited search space information 26 described later is given as an example of the second search space.

The output control unit 5 outputs second search space information relating to the second search space to an output device. An output control unit 16 described later is given as an example of the output control unit 5. The limited search space information 26 described later is given as an example of the second search space information. The output device may be, for example, a storage device (including a built-in storage device and an external storage device), a display device, a communication interface, another computer, or a data writer capable of writing data to a storage medium.

By adopting such a configuration, the possibility that a neural network generated by a neural architecture search will include an irregular architecture or an architecture whose purpose is difficult to comprehend can be reduced.

The generation unit 3 generates neural network architecture information including parameters representing the architecture of the first neural network. The determination unit 4 determines the second search space, based on the allowable distance from the parameters representing the architecture of the first neural network with respect to respective parameters representing the first search space.

By adopting such a configuration, a neural architecture search can be performed in a search range limited from the analyzed neural network architecture information. As a result, the possibility that a neural network generated by a neural architecture search will include an irregular architecture or an architecture whose purpose is difficult to comprehend can be reduced.

Also, the determination unit 4 may determine the second search space, based on whether there is a change in the type of possible values of each or any of the parameters representing the architecture of the first neural network with respect to the respective parameters representing the first search space.

By adopting such a configuration, the example embodiment can be applied even if the order relationship does not hold between possible values of the parameters in the case where the possible values include different types of values.

Also, the determination unit 4 may weight the allowable distance of the parameters representing the architecture of the first neural network with respect to the respective parameters representing the first search space. By adopting such a configuration, limited search space information corresponding to a parameter of interest can be created, by weighting parameters according to the parameter of interest, for example.

Also, the determination unit 4 may apply the same allowable distance or different allowable distances to the parameters representing the architecture of the first neural network with respect to the respective parameters representing the first search space, based on the allowable distance information. By adopting such a configuration, the degree of freedom of the allowable distance with respect to the parameters can be enhanced.

Also, the determination unit 4 may determine the second search space, based on the sum of the allowable distances of the respective parameters representing the architecture of the first neural network with respect to the respective parameters representing the first search space. By adopting such a configuration, a variation of the limited search space can be obtained.

Also, the determination unit 4 may determine the second search space, based on the number of parameters that are changed among the parameters representing the architecture of the first neural network with respect to the respective parameters representing the first search space. By adopting such a configuration, limited search space information can be created, according to the number of parameters that are changed.

### [System Configuration]

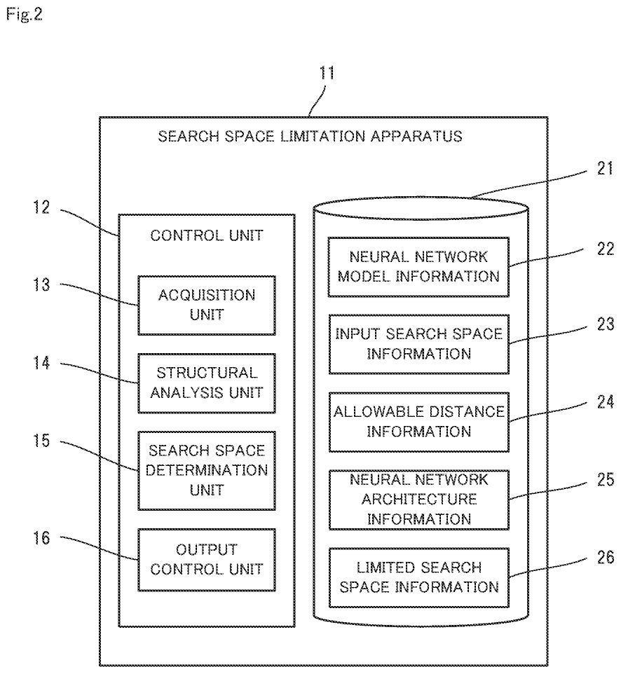

Next, the configuration of the search space limitation apparatus 1 in the example embodiment will be more specifically described using FIG. 2. Hereinafter, the search space limitation apparatus 11 is given as an example of the search space limitation apparatus 1.

FIG. 2 is a block diagram for describing an example of the overall configuration of the search space limitation apparatus in the example embodiment. The search space limitation apparatus 11 is an information processing apparatus such as a computer equipped with a control unit 12 and a storage unit 21.

The control unit 12 is a processor that controls the operations of the search space limitation apparatus 11, and may be constituted by a programmable device such as a CPU (Central Processing Unit) or an FPGA (Field-Programmable Gate Array), or by a GPU (Graphics Processing Unit), or by a circuit equipped with one or more thereof.

The control unit 12 functions as the acquisition unit 13, the structural analysis unit 14, the search space determination unit 15 and the output control unit 16, by executing a program of the example embodiment.

The acquisition unit 13 acquires neural network model information 22, input search space information 23 and allowable distance information 24 input to the search space limitation apparatus 11. In the case where the neural network model information 22, the input search space information 23 and the allowable distance information 24 are stored in the storage unit 21 in advance, the acquisition unit 13 may acquire the neural network model information 22, the input search space information 23 and the allowable distance information 24 from the storage unit 21.

The neural network model information 22 is information relating to a base model of a neural network such as ResNet (Residual Network) or M2Det, for example. Note that the neural network model information 22 is not limited to information relating to the base model of ResNET or M2Det, and may be information relating to the base model of any neural network that is input by a user. The input search space information 23 is information relating to parameters constituting the search space of a neural architecture search (NAS). The allowable distance information 24 is information relating to the distance (e.g., Hamming distance) that is allowed from the parameters of the neural network architecture of the base model with respect to the respective parameters of the search space.

The structural analysis unit 14 analyzes the architecture of the base model of the neural network, based on the neural network model information 22 acquired by the acquisition unit 13, and generates neural network architecture information 25. The neural network architecture information 25 is information relating to the analyzed neural network architecture of the neural network model (base model). The generated neural network architecture information 25 may be stored in the storage unit 21 temporarily or long term.

The search space determination unit 15 determines, in the search space corresponding to the input search space information 23, a search space limited by the allowable distance information 24, using the neural network that is represented by the neural network architecture information 25 as the base model, and generates the limited search space information 26. The search space limited by the allowable distance information 24 is, for example, a search space in which the search range of parameters is limited such that the distance from the respective parameters of the neural network architecture of the base model is not greater than the allowable distance. The limited search space information 26 is information relating to the search space in which the search range of parameters is limited such that the distance from the respective parameters of the neural network architecture of the base model is not greater than the allowable distance.

The output control unit 16 outputs the limited search space information 26 to the storage unit 21. In the example embodiment, the limited search space information 26 is output to the storage unit 21 as an example, but is not limited thereto. The output control unit 16 may also output the limited search space information 26 to a display device, a communication interface, another computer, a data writer capable of writing data to a storage medium, or the like.

The storage unit 21 is a magnetic disk storage device such as a hard disk drive or a semiconductor storage device such as an SSD (Solid State Drive). The storage unit 21 stores the neural network model information 22, the input search space information 23, the allowable distance information 24, the neural network architecture information 25 and the limited search space information 26, for example. Note that the storage unit 21 is not limited to a storage device built into the search space limitation apparatus 11, and may be an external storage device, or a storage device that is built into or external to an external computer.

Note that the example embodiment is described assuming that a human-designed neural network is used as the neural network model information 22, but is not limited thereto. For example, information relating to a neural network model automatically generated by a neural network search technology may be used as an input, and the difference from the generated neural network model may be used to perform a search in a predetermined range.

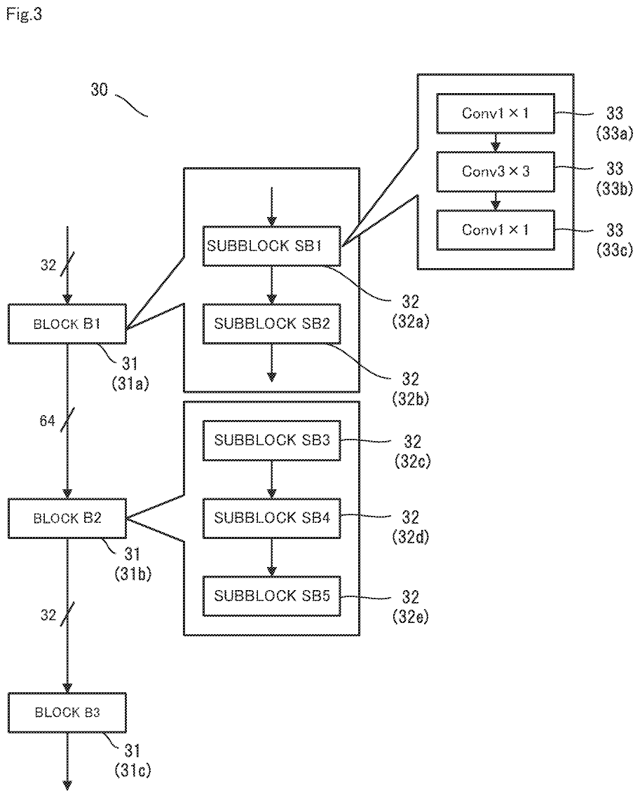

FIG. 3 is a diagram illustrating an example of a neural network model that is represented by neural network model information in the example embodiment. The neural network model that is represented by the neural network model information 22 includes a plurality of processing blocks (hereinafter, the processing blocks will be referred to as “blocks”). A block is processing unit, and predetermined processing is performed in units of blocks. For example, in neural networks that perform image analysis, processing is often performed with the resolution of the input image scaled down slightly, and the blocks can be thought of as a series of processing that corresponds to respective resolutions. Each block further includes a plurality of small processing units (hereinafter, the small processing units within each block will be referred to as “subblocks”). The number of filters that are used in each block is called the channel count.

The subblocks each include a plurality of layers. A layer is a component that is the smallest structural unit and is used when constructing and designing neural networks. Types of layers include, for example, fully connected layers, convolutional layers and pooling layers.

In the example in FIG. 3, the blocks are denoted by reference numeral 31, the subblocks are denoted by reference numeral 32, and the layers are denoted by reference numeral 33. In the example in FIG. 3, a neural network model 30 that is represented by the neural network model information 22 includes three blocks (31), namely, a block B1 (31a), a block B2 (31b) and a block B3 (31c). The input channel count of the block B1 (31a) is 32. The input channel count of the block B2 (31b) is 64. The input channel count of the block B3 (31c) is 32. Hereinafter, the “input channel count” will be simply referred to as “channel count”. Note that the example embodiment is described taking the input channel count as an example of the channel count of the blocks, but is not limited thereto, and the output channel count of the blocks may be taken as the channel count of the blocks.

For example, the block B1 (31a) includes two subblocks (32), namely, a subblock SB1 (32a) and a subblock SB2 (32b). For example, the block B2 (31b) includes three subblocks (32), namely, a subblock SB3 (32c), a subblock SB4 (32d) and a subblock SB5 (32e).

For example, the subblock SB1 (32a) includes three convolutional layers (33) that are represented by Conv1×1 (33a), Conv3×3 (33b) and Conv1×1 (33c). Conv1×1 (33a, 33c) represents a convolutional layer having a kernel size 1×1. Conv3×3 (33b) represents a convolutional layer having a kernel size 3×3.

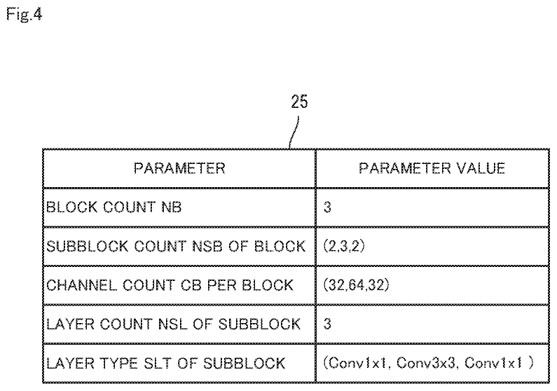

FIG. 4 is a diagram illustrating an example of neural network architecture information in the example embodiment. The neural network architecture information 25 is indicated by specific values for the parameters of the neural network architecture. The round parentheses “( )” in the diagram indicate a vector value composed of multiple values. The neural network architecture information 25 includes, for example, parameter items “block count NB”, “subblock count NSB of block”, “channel count CB per block”, “layer count NSL of subblock”, and “layer type SLT of subblock”. In the parameter “block count NB” is stored the number of blocks in the neural network model. In the parameter “subblock count NSB of block” is stored the number of subblocks that are included in each block. In the parameter “channel count CB per block” is stored the number of channels per block. In the parameter “layer count NSL of subblock” is stored the number of layers in the subblocks. In the parameter “layer type SLT of subblock” is stored the type of layers in the subblocks.

In the example in FIG. 4, the block count NB indicates that the number of blocks in the neural network model is 3. Also, the subblock count NSB of the three blocks is indicated as 2, 3 and 2, respectively. Also, the channel count CB of the blocks is indicated as 32, 64 and 32, respectively. Also, the layer count NSL of the subblocks is indicated as 3. Also, the layer type SLT of the respective layers is indicated as a convolutional layer having a kernel size 1×1 (Conv1×1), a convolutional layer having a kernel size 3×3 (Conv3×3), and a convolutional layer having a kernel size 1×1 (Conv1×1). Here, ConvN×N (where N is an integer) represents a convolutional layer that uses an N×N filter (kernel).

Note that the parameters shown in FIG. 4 are given as examples, and parameters may be added or removed according to the architecture of the neural network to be designed. For example, a coefficient (so-called expansion ratio) in the case of changing the channel count within the subblocks may be added as a parameter.

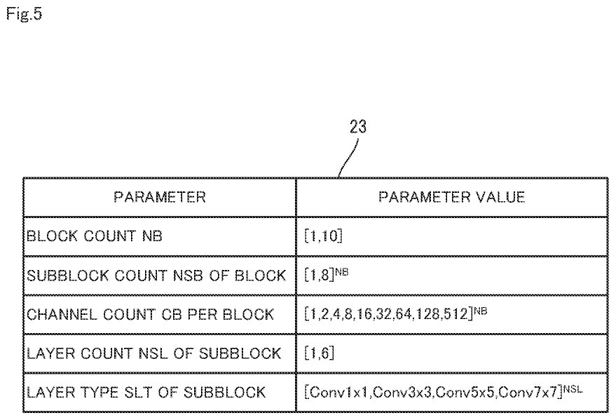

FIG. 5 is a diagram illustrating an example of input search space information in the example embodiment. The input search space information 23 is represented by a range of possible parameter values for the respective parameters of the neural network architecture information 25. The square parentheses “[ ]” in the diagram show the range of possible values. For example, assume “[1:5]” indicates natural numbers in a range from 1 to 5. Also, the value on the upper right of square parentheses indicates the length of the vector. For example, “[1:5]³” indicates a vector composed of three natural numbers in a range from 1 to 5. Also, for example, [1, 2, 4, 8]³ indicates that three vectors can each take the value of any of the four types 1, 2, 4 and 8.

That is, in the example in FIG. 5, the block count NB indicates that a value in a range from 1 to 10 can be taken. Also, the subblock count NSB of each block indicates that NB number of values can each take a value in a range from 1 to 8. Also, the channel count CB per block indicates that NB number of values can each take a number to the power of 2 from 1 to 512. Also, the layer count NSL of each subblock indicates that a value in a range from 1 to 6 can be taken. Also, the layer type SLT in each subblock indicates that NSL number of values can each take the values of any of the four types Conv1×1, Conv3×3, Conv5×5 and Conv7×7.

Note that the parameter items and possible values of the parameters shown in FIG. 5 are given as examples, and may be changed according to the architecture of the neural network to be designed. For example, the possible values of the channel count CB per block may be not only powers of 2 but also all natural numbers from 1 to 512. Also, a maximum pooling (max pooling) layer and an identity layer may be included in addition to the convolutional layers as a possible value of the layer type SLT in each subblock. Also, in order to represent architectures such as shown in Non-Patent Document 2, a parameter for designating the connection relationship between layers in the subblocks may be added.

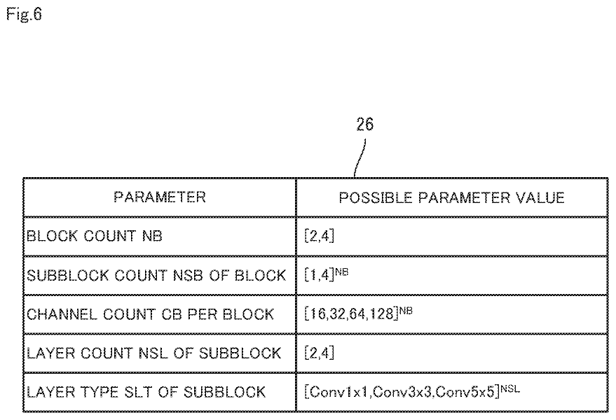

FIG. 6 is a diagram illustrating an example of limited search space information that is generated by the search space determination unit in the example embodiment. The limited search space information 26 is represented by a range of possible parameter values for the respective parameters of the neural network architecture information 25, similarly to the input search space information 23.

FIG. 6 shows an example of the case in which the allowable distance is set to 1 with respect to the neural network architecture information 25 shown in FIG. 4 and the input search space information 23 shown in FIG. 5. For example, the possible values of the block count NB in the input search space information 23 are in a range from 1 to 10. On the other hand, the block count NB in the neural network architecture information 25 is 3. In this case, the range of possible values of the block count NB in the limited search space information 26 will be a range in which the difference from 3 is not greater than the allowable distance “1”, that is, a range from 2 to 4.

Also, the possible values of the subblock count NSB of each block in the input search space information 23 are in a range from 1 to 8. The subblock count NSB of each block in the neural network architecture information 25 is (2, 3, 2), that is, a value in a range from 2 to 3. In this case, the range of possible values of the subblock count NSB of each block in the limited search space information 26 will be a range in which the difference from the range of 2 to 3 is not greater than the allowable distance “1”, that is, a range from 1 to 4.

Also, the possible values of the channel count CB per block in the input search space information are in a range of the power of 2 from 1 to 512. The channel count CB per block in the neural network architecture information 25 is (32, 64, 32), that is, a value in a range of the power of 2 from 32 to 64. In this case, the range of possible values of the channel count CB per block in the limited search space information 26 will be a range in which the difference from the range of the power of 2 from 32 to 64 is not greater than the allowable distance “1”, that is, a range of the power of 2 from 16 to 128.

The possible values of the layer count NSL of each subblock in the input search space information 23 are in a range from 1 to 6. The layer count NSL of each subblock in the neural network architecture information 25 is 3. In this case, the range of possible values of the layer count NSL of each subblock in the limited search space information 26 will be a range in which the difference from 3 is not greater than the allowable distance “1”, that is, a range from 2 to 4.

Assume that the possible values of the layer type SLT in each subblock in the input search space information 23 are in the range Conv1×1, Conv3×3, Conv5×5 and Conv7×7, and are defined in the order of the of N×N values. The layer type SLT in each subblock in the neural network architecture information 25 is (Conv1×1, Conv3×3, Conv1×1), that is, a value in the range from Conv1×1 to Conv3×3. In this case, the range of possible values of the layer type SLT in each subblock in the limited search space information 26 will be a range in which the difference from Conv1×1 to Conv3×3 is not greater than the allowable distance “1”, that is, a range from Conv1×1 to Conv5×5.

Note that, in the above-described example embodiment, the allowable distance for the respective parameters is described as being set to 1, but is not limited thereto. The allowable distance for the respective parameters may be set as necessary to 2, 3, 4 and so on, for example.

Also, the allowable distance may differ for each parameter. For example, the parameter “block count NB” may be set such that the range of possible values of the block count NB is a range in which the difference is not greater than an allowable distance “2”, and the parameter “subblock count NSB of each block” may be set such that the range of possible values of the subblock count NSB of each block is a range in which the difference is not greater than an allowable distance “3”.

Also, in order to adjust the limited search space according to the resources or performance of hardware such as the size and the like of the CPU, GPU (Graphics Processing Unit) and memory of the device that performs the architecture searches, an allowable distance that corresponds to the limited search space may be set.

Also, the example embodiment is described assuming that the order is defined in the range of possible values in the input search space information 23, but the order need not be defined. For example, when convolutional layers and a max pooling layer are included as possible values of the layer type SLT in each subblock, it is difficult to specify the order, unlike the ConvN×N example described above. In this case, the distance may be defined as 1 if there is a change in the type of possible values of the parameter, and 0 if there is no change. For example, in the case where a max pooling layer MaxPool is included in addition to the convolutional layers as a possible value of the layer type SLT in each subblock, the range of possible values of the parameter will be [Conv1×1, Conv3×3, Conv5×5, MaxPool]. In this case, it is difficult to define an order relationship between MaxPool and Conv1×1, Conv3×3 and Conv5×5. In view of this, in this case, the distance may be defined as 1 if the layer type SLT in each subblock is changed from ConvN×N to MaxPool, and as 0 if there is no change, without defining the order between ConvN×N and MaxPool. For example, if the layer type SLT in each subblock in the neural network architecture information 25 is Conv1×1, the range of possible values of the layer type SLT in each subblock in the case where a distance not greater than 1 is allowed may be [Conv1×1, Conv3×3, MaxPool]. In other words, the range in which the difference from Conv1×1 is not greater than the allowable distance “1” includes not only Conv3×3 with respect to which the order relationship holds but also MaxPool with respect to which the order relationship does not hold, that is, with respect to which the type of possible values of the parameter is different.

Also, the example embodiment is described assuming that the weight for each parameter is constant, but a configuration may be adopted in which the weight at the time of distance calculation can be designated for each parameter. For example, the case where the weight of the block count NB is 0.5 will be illustrated. In the case where the block count NB in the neural network architecture information 25 is 3, the distance from 3 to 5 would usually be 5−3=2, but when the weight is 0.5, the distance is deemed to be (5−3)×0.5=1, for example. A range from 1 to 5 may thus be allowed with the distance set to 1 when the weight is 0.5.

Also, the example embodiment is described assuming that the distance allowed for each parameter is independently evaluated, but a configuration may be adopted in which the sum of the differences of the parameters is evaluated as the allowable distance. This will, first, be described taking the case where the allowable distance for the sum of the differences of the parameters is 1 as an example. Under this condition, in the example of the above-described example embodiment, the allowable distance of the range of possible values of any one of the five parameters is 1; that is, any one of the five parameters is allowed to increase or decrease by one step. There are 2×5=10 patterns in which any one of the five parameters is allowed to increase or decrease by one step. Accordingly, the limited search space information 26 is search space information composed of sets of these 10 patterns.

Next, the case where the allowable distance for the sum of the differences of the parameters is 2 will be described as an example. In this case, in the example of the above-described example embodiment, there is a case where the allowable distance of the range of possible values of any two of the five parameters is 2 (case I), and a case where the allowable distance of the range of possible values of any one of the five parameters is 2 (case II). The case where the allowable distance of the range of possible values of any two of the five parameters is 2 (case I) means that any two of the five parameters are each allowed to increase or decrease by one step. In this case, the number of combinations obtained by selecting any two parameters from the five parameters is 10. With regard to one combination, if the allowable distance of the range of values that each parameter can take is not greater than 1, there are 2\hat{ }2=4 patterns. Accordingly, in case I, there are 10×4=40 patterns of parameter combinations. Next, the case where the allowable distance of the range of possible values of any one of the five parameters is 2 (case II) means that any one of the five parameters is allowed to increase or decrease by 2 steps. In this case, the number of combinations obtained by selecting any one of the five parameters is 5. With regard to one combination, if the allowable distance of the range of values that one parameter can take is not greater than 2, there are 4 patterns. Accordingly, in case II, there are 5×4=20 patterns of parameter combinations. Accordingly, the limited search space information 26 is search space information composed of sets of 40+20=60 patterns.

Also, a configuration may be adopted in which the number of parameters that have been changed is evaluated as the distance, instead of the difference for each parameter. For example, if only one of the five parameters is changed in the case where the allowable distance is 1, the allowable distance may be deemed to be 1 regardless of the range of values after the change. Also, if up to two of the five parameters are changed in the case where the allowable distance is 2, the allowable distance may be deemed to be 2, regardless of the range of values after the change.

### [System Operations]

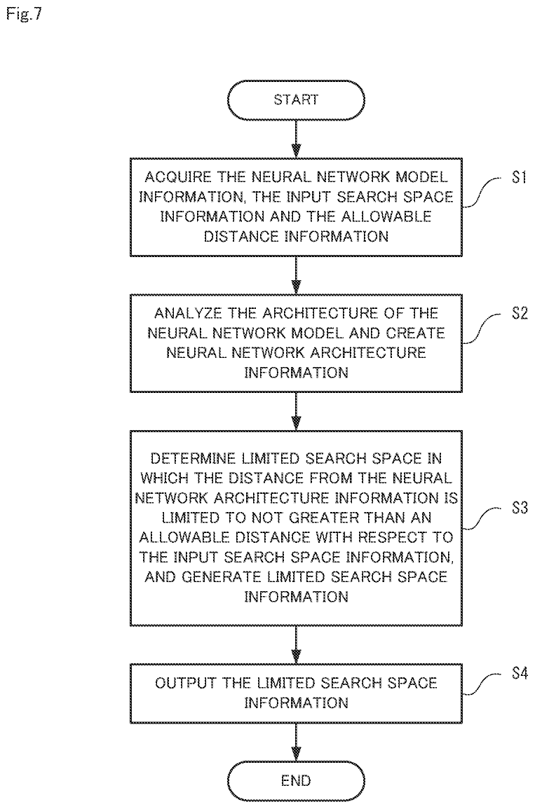

FIG. 7 is a flowchart illustrating an example of the operations of the search space limitation apparatus in the example embodiment. Neural network model information 22, input search space information 23 and allowable distance information 24 relating to the base model of the neural network are input to the search space limitation apparatus in advance and stored in the storage unit 21.

First, the acquisition unit 13 acquires the neural network model information 22, the input search space information 23 and the allowable distance information 24 from the storage unit 21 (step S1).

Next, the structural analysis unit 14 analyzes the architecture of the neural network model using the neural network model information 22 and creates neural network architecture information 25 (step S2). Here, the structural analysis unit 14 detects the parameters and values of the block count NB, the subblock count NSB of each block, the channel count CB per block, the layer count NSL of each subblock and the layer type SLT in each subblock from the neural network model information 22, for example. The structural analysis unit 14 then creates the neural network architecture information 25, based on the detected parameters and values.

Next, the search space determination unit 15 generates limited search space information 26, based on the input search space information 23, the allowable distance information 24 and the neural network architecture information 25 read out from the storage unit 21. Here, the search space determination unit 15 determines a search space (limited search space) in which the distance from the neural network architecture information 25 is limited to not greater than an allowable distance with respect to the input search space information 23, and generates limited search space information 26 relating to the limited search space (step S3). The output control unit 16 outputs the limited search space information 26 to the storage unit 21 (step S4).

### [Effect of Embodiment]

According to the example embodiment, the likelihood that a neural network generated by a neural architecture search will include an irregular architecture or an architecture whose purpose is difficult to comprehend can be reduced. That is, searches can only be performed for neural networks having a limited difference architecture with respect to a given known neural network architecture. The likelihood that a neural network obtained as a result of a search will include an irregular architecture or an architecture whose purpose is difficult to comprehend can thereby be reduced.

### [Program]

The program according to the example embodiment may be a program that causes a computer to execute the processes described in FIG. 7. By installing this program in a computer and executing the program, the search space limitation apparatus and the search space limitation method according to the example embodiment can be realized. Further, the processor of the computer performs processing to function as the acquisition unit 13, the structural analysis unit 14, the search space determination unit 15 and the output control unit 16.

Also, the program according to the example embodiment may be executed by a computer system constructed by a plurality of computers. In this case, for example, each computer may function as any of the acquisition unit 13, the structural analysis unit 14, the search space determination unit 15 and the output control unit 16.

In the example embodiment, the storage unit 21 may be realized by storing the data files that comprise them in a hard disk or other storage device provided in a computer, or it may be realized by a storage device in another computer.

### [Physical Configuration]

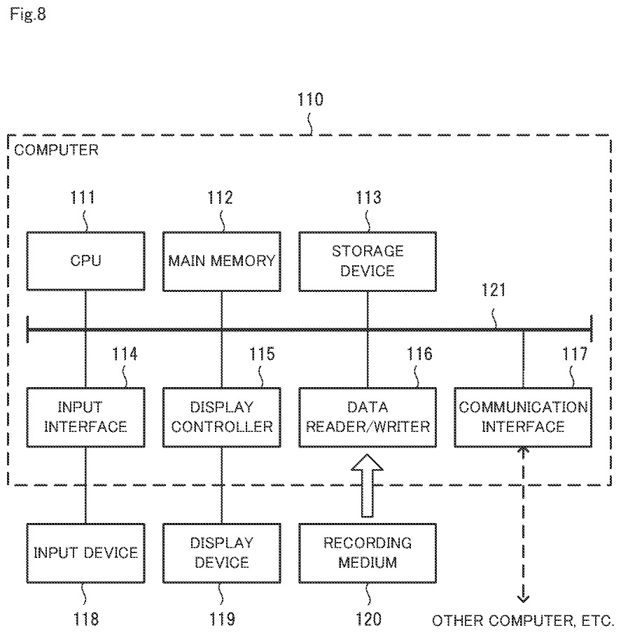

Here, a computer that realizes an information processing apparatus by executing the program according to the example embodiment will be described with reference to FIG. 8. FIG. 8 is a block diagram showing an example of a computer that realizes the search support apparatus according to an example embodiment of the present invention.

As shown in FIG. 8, a computer 110 includes a CPU 111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU or a FPGA in addition to the CPU 111 or instead of the CPU 111.

The CPU 111 loads a program (codes) according to the first and second example embodiments and the first and second working examples stored in the storage device 113 to the main memory 112, and executes them in a predetermined order to perform various kinds of calculations. The main memory 112 is typically a volatile storage device such as a DRAM (Dynamic Random Access Memory). Also, the program according to the first and second example embodiments and the first and second working examples are provided in the state of being stored in a computer-readable recording medium 120. Note that the program according to the first and second example embodiments and the first and second working examples may be distributed on the Internet that is connected via the communication interface 117.

Specific examples of the storage device 113 include a hard disk drive, and a semiconductor storage device such as a flash memory. The input interface 114 mediates data transmission between the CPU 111 and the input device 118 such as a keyboard or a mouse. The display controller 115 is connected to a display device 119, and controls the display of the display device 119.

The data reader/writer 116 mediates data transmission between the CPU 111 and the recording medium 120, and reads out the program from the recording medium 120 and writes the results of processing performed in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The information processing apparatus according to the first and second example embodiments and the first and second working examples can also be achieved using hardware corresponding to the components, instead of a computer in which a program is installed. Furthermore, a part of the information processing apparatus may be realized by a program and the remaining part may be realized by hardware.

Although the invention of this application has been described with reference to the first and second example embodiments and the first and second working examples, the invention of this application is not limited to the above example embodiment. Within the scope of the invention of this application, various changes that can be understood by those skilled in the art can be made to the configuration and details of the invention of this application.

According to the disclosed technology described above, neural architecture search can be easily applied to real-world applications because neural networks generated by neural architecture search are less likely to include an irregular architecture and an architecture whose purpose is difficult to comprehend. For example, it can be applied to applications such as improving the recognition accuracy or speeding up the object detection system using a camera.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

What is claimed is:

1. A search space limitation apparatus comprising:
an acquisition unit that acquires first neural network information relating to a first neural network, first search space information relating to a first search space which is a range for searching for an architecture of a second neural network based on the first neural network, and allowable distance information relating to an allowable distance indicating a degree of change in an architecture allowed from an architecture of the first neural network in the first search space;
a generation unit that generates neural network architecture information relating to the architecture of the first neural network, based on the first neural network information;
a determination unit that determines a second search space which is a range, in the first search space, for searching for the architecture of the second neural network, based on the neural network architecture information, the first search space information and the allowable distance information; and
an output control unit that outputs second search space information relating to the second search space to an output device.

2. The search space limitation apparatus according to claim 1,
wherein the generation unit generates neural network architecture information including parameters representing the architecture of the first neural network, and
the determination unit determines the second search space, based on the allowable distance from the parameters representing the architecture of the first neural network with respect to respective parameters representing the first search space.

3. The search space limitation apparatus according to claim 1,
wherein the determination unit determines the second search space, based on whether there is a change in a type of a possible value of each or any of the parameters representing the architecture of the first neural network with respect to parameters representing the first search space.

4. The search space limitation apparatus according to claim 1,
wherein the determination unit weights the allowable distance of parameters representing the architecture of the first neural network with respect to respective parameters representing the first search space.

5. The search space limitation apparatus according to claim 1,
wherein the determination unit applies the same allowable distance or different allowable distances to the parameters representing the architecture of the first neural network with respect to respective parameters representing the first search space, based on the allowable distance information.

6. The search space limitation apparatus according to claim 1,
wherein the determination unit determines the second search space, based on a sum of the allowable distances from parameters representing the architecture of the first neural network with respect to respective parameters representing the first search space.

7. The search space limitation apparatus according to claim 1,
wherein the determination unit determines the second search space, based on the number of parameters that are changed among parameters representing the architecture of the first neural network with respect to respective parameters representing the first search space.

8. A search space limitation method executable by a computer, the method comprising:
acquiring first neural network information relating to a first neural network, first search space information relating to a first search space which is a range for searching for an architecture of a second neural network based on the first neural network, and allowable distance information relating to an allowable distance indicating a degree of change in an architecture allowed from an architecture of the first neural network in the first search space;
generating neural network architecture information relating to the architecture of the first neural network, based on the first neural network information;
determining a second search space which is a range, in the first search space, for searching for the architecture of the second neural network, based on the neural network architecture information, the first search space information and the allowable distance information; and
outputting second search space information relating to the second search space to an output device.

9. A non-transitory computer readable recording medium that includes a program recorded thereon, the program including instructions that cause a computer to carry out:
acquiring first neural network information relating to a first neural network, first search space information relating to a first search space which is a range for searching for an architecture of a second neural network based on the first neural network, and allowable distance information relating to an allowable distance indicating a degree of change in an architecture allowed from an architecture of the first neural network in the first search space;
generating neural network architecture information relating to the architecture of the first neural network, based on the first neural network information;
determining a second search space which is a range, in the first search space, for searching for the architecture of the second neural network, based on the neural network architecture information, the first search space information and the allowable distance information; and
outputting second search space information relating to the second search space to an output device.

10. The non-transitory computer readable recording medium according to claim 9,
wherein, in the generating, neural network architecture information including parameters representing the architecture of the first neural network is generated, and
in the determining, the second search space is determined, based on the allowable distance from the parameters representing the architecture of the first neural network with respect to respective parameters representing the first search space
